(19) United States
(12) Patent Application Publication
(10) Pub. No.: US 2005/0073265 A1
(43) Pub. Date: Apr. 7, 2005

(54) Direct electric current decorative lamps

(76) Inventor: Min-Hsien Wang, Yan Mei (TW)

Correspondence Address: Jing Shiarn Wang, 4508 Greenwood Rd., Beltsville, MD, 20705, US

(21) Appl. No.: 10/679,345

(22) Filed: Oct. 7, 2003

Related U.S. Application Data
(60) Provisional application No. 60/416,245, filed on Oct. 7, 2002.

(51) Int. Cl. H05B 37/00

(52) U.S. Cl. 315/185 S

(57) ABSTRACT

The invented decorative lamp includes a graphic designed surface, fiber optics, light sources, a control unit, and a battery unit. The graphic designed surface has embedded many small clear glass balls. When the light is on, the clear glass balls reflect the light and make the lamp even more colorful. The outline of the graphic pattern is defined by many see-through holes. These holes allow lights too shine through. Fiber optics transmits the light. One end of the fiber optics is mounted to the see-through holes that define the outline of the graphic pattern. The other end of the fiber optics is assembled and bundled into groups. Each group is attached to a light source. The light sources are single-colored light emitted diodes (LEDs). A battery operated control unit modulates the light emitting pattern and sound. The use of fiber optics and LEDs allows a more elaborative and complex graphic design in a much smaller lamp surface. This lamp is compact and easy to adapt to various decorative settings. Not only the lamp cost less to produce, the lamp has a lower defect rate with a wider range of application.

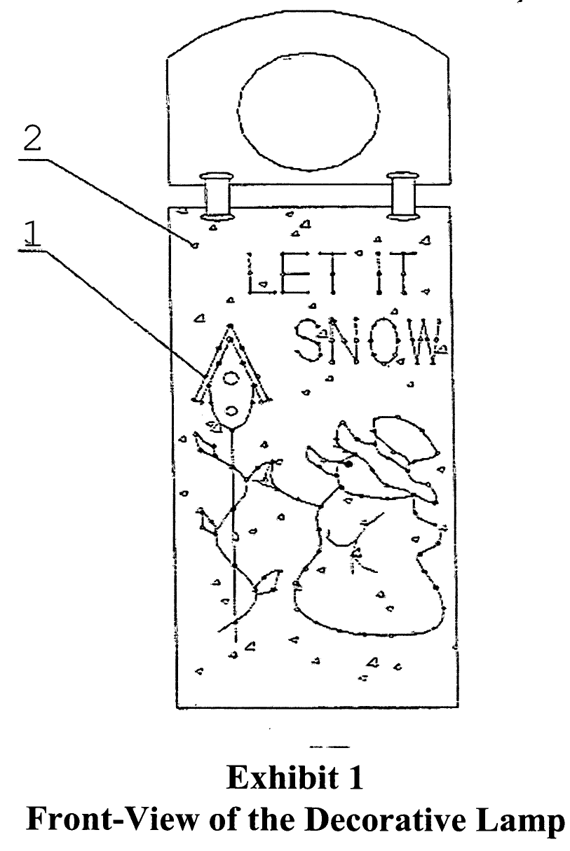

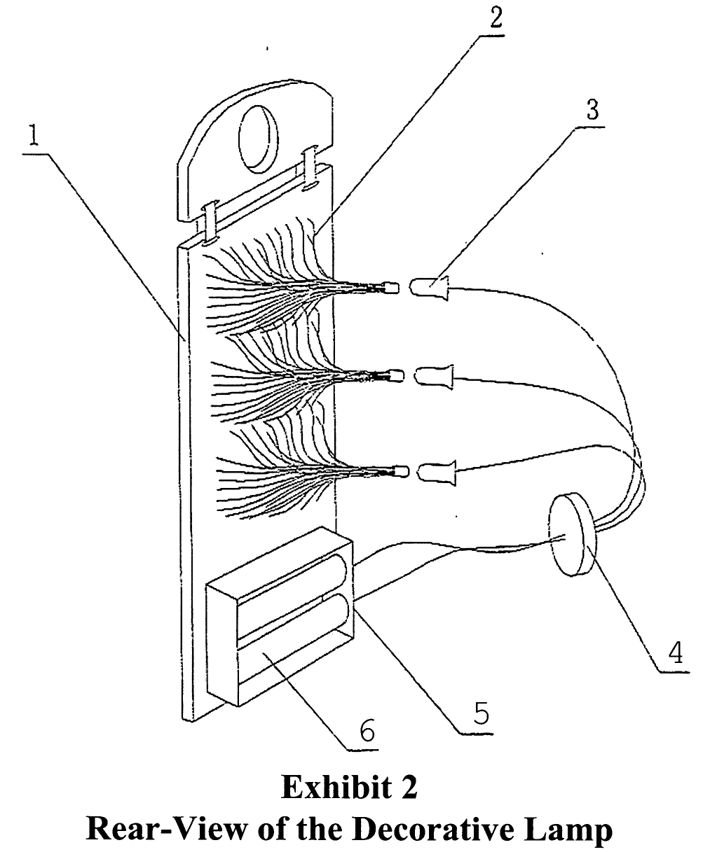

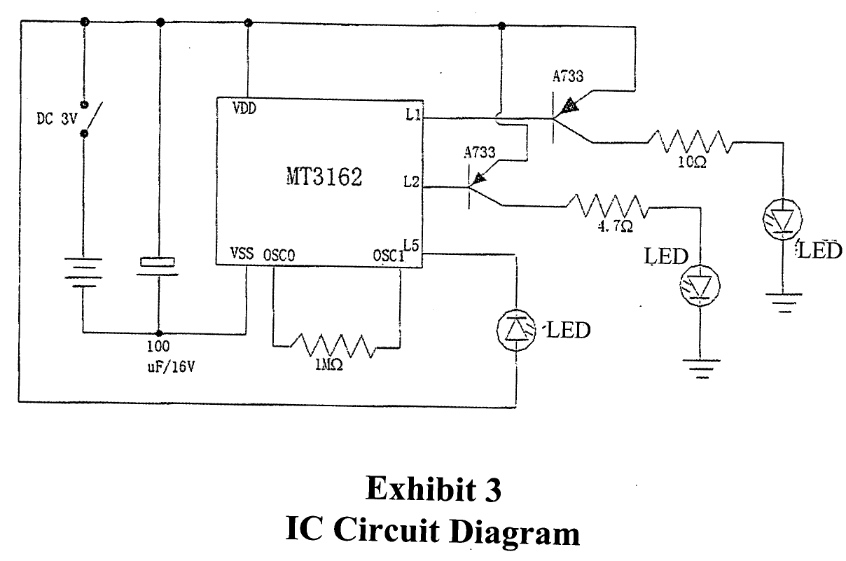

### BACKGROUND OF THE INVENTION

1. Field of Invention

The present invention relates to decorative lamps that are used for the festivity atmosphere and particularly to lights and ornaments for Christmas.

2. Background of the Invention

Families and business use the decorative lamps to celebrate the traditional holidays, especially during the Christmas holiday season. Many decorated the Christmas trees, the streets, the houses, and the buildings with extra lights to enhance the festivity atmosphere. These decorative lamps wire a series of single colored light bulbs together to illuminate a theme. Due to factors such as wiring, number of bulbs needed, and the high electric power consumption, the Christmas decorative lamps or any other similar decorative lamps usually are simple in design and lack of variations. More complex and elaborate visual effects can be achieved but these effects require a considerably more physical space and materials.

Currently, many decorative lamps have used fiber optics to reduce the weight and volume, and space. Most of these lamps include a single-colored light bulb, colorful platters, fiber optics, and an electric powered motor. The fiber optics is attached to the back surface of the lamps and the colorful platters. When the motor rotates the colorful platters around the light bulb, the colorful lights are transmitted through the fiber optics to achieve the colorful light effects. More light patterns can be achieved by this design. However, the lamps have more components because of its mechanic structure. More components increase the production complexity, electricity consumption, and the defect rates. Thus, the lamps have a higher production costs. This kind of lamps usually is big and lack of flexibility in decoration.

### BRIEF SUMMARY OF THE INVENTION

The invented decorative lamp includes a graphic designed surface, fiber optics, light sources, a control unit, and a battery unit. The invented lamp surface can be made by a verity of materials with different graphic patterns and shapes. In this invention, the graphic designed surface has embedded with many small clear glass balls. When the light is on, the clear glass balls reflect the light and make the lamp even more colorful. The outline of the graphic on the lamp surface is defined by many small see-through holes. These holes allow the lights to shine through. Fiber optics transmits the lights. In the back of the lamp surface, these holes are filled with fiber optics. In other words, one end of the fiber optics is mounted on the back of the lamp surface around the graphic pattern. The other end of the fiber optics is assembled and attached to the light sources. The fiber optics is bundled into groups. The number of groups corresponds to the number of light sources. The light sources are single-colored light emitted diodes (LEDs) or other light sources that are deem to be appropriate. These LEDs link to a control unit. The control unit contains an IC to modulate the light emitting pattern and sounds. The other end of control unit is connected to the battery housing.

The use of fiber optics allows a more elaborative and complex graphic design in a smaller lamp surface. This design requires less material and production costs than the traditional all-wired lamps and current decorative lamps as previously described in the background section. In addition, the invented decorative lamp has a lower defect rate. It is compact and easy to adapt to various decorative settings. The invented lamp potentially has a wider range of applications and a higher customer acceptance rate.

### BRIEF DESCRIPTION OF THE SEVERAL VIEWS OF THE DRAWING

There are three drawings included.

Exhibit 1 illustrates the front view of the decorative lamp.

Exhibit 2 illustrates the rear view of the decorative lamp.

Exhibit 3 illustrates the IC flow chart that is included in the control unit.

### EXHIBIT 1—FRONT-VIEW OF DECORATIVE LAMP (LAMP SURFACE)

Exhibit 1 uses “Let It Snow” as an example to depict the front-view design of the lamp surface. The lamp surface basically contains (1) a graphic and/or text design pattern with many small see-through holes on the outline of the graphics and (2) small clear glass balls that are embedded in the area other than the outline. The see-through holes allow lights to shine through. The clear glass balls function as the reflectors that enhance the color of the lamp.

1. See-Through Holes
The graphic design on the lamp surface are painted with colored shining paints. There are many small see-through holes 1 on the outline of the graphic design (including the shape of the lamp). These holes are for lights to shine through. On the back of the surface, these holes are filled with fiber optics.

2. Glass Balls
Glass balls 2 are mounted on the area other than the outline of the graphic.

The glass balls serve as the light reflecting devices and make the lamp lighting more dramatic and colorful.

### EXHIBIT 2—REAR-VIEW OF THE DECORATIVE LAMP

Exhibit 2 depicts the rear-view design of the invented lamp. The rear-view structure of the invented decorative lamp contains (1) the lamp surface, (2) fiber optics, (3) light sources, (4) control unit, (5) battery housing, and (6) batteries. The followings are descriptions of each part:

1. Lamp Surface
The front of lamp surface has a complex graphic design. There are many small see-through holes define the outline of the graphic design. In the back, these holes are filled with fiber optics is attached to these holes.

2. Fiber Optics
The fiber optics transmits the lights. One end of the fiber optics is mounted on the back of the lamp around the outline of the graphic pattern, i.e., attached to the see-through holes. The other end of the fibers is assembled and bundled into groups. The number of groups corresponds to the number of lights used. Each group is connected to a light source.

3. Light Sources
The light sources are single-colored LEDs such as red, blue, and yellow LEDs or others that are appropriate for the design.

4. Control Unit
The control unit contains an IC to modulate the light emitting pattern and sound. The unit is powered by batteries.

5. Battery Housing
For batteries

### EXHIBIT 3—IC CIRCUIT DIAGRAM

Exhibit 3 illustrates the circuit flow diagram that included in the control unit. This diagram is a MT3162 model IC. Each of the three outlet L1, L2 and L3 is connected to a single-colored light source, i.e., LEDs. This IC controls the current, voltage, and the lighting pattern such as the illuminating sequence, light starting time, and duration. This pre-defined lighting pattern makes the lamp illuminate with different graphic and intensity, and thus, achieve a more complex and colorful visual effects.

### DETAILED DESCRIPTION OF THE INVENTION

The invented decorative lamp includes (1) a lamp surface, (2) fiber optics, (3) light sources, (4) a control unit, and (5) a battery housing. The lamp surface has a graphic design including picture and text. The whole surface and the graphics are painted with colored and shining paints. There are many small see-through holes 1 of Exhibit 1 on the outline of each graphic. These small holes allow lights to shine through. The fiber optics transmits the lights. On the back of the lamp surface, these holes are filled with fiber optics 2 of Exhibit 2. Other area of the front surface are embedded with many small glass balls. These glass balls 2 of Exhibit I function as the reflectors. When the light is on, the clear glass balls reflect the light and make the lamp even more colorful. Exhibit 1 illustrates the lamp surface design.

Exhibit 2 illustrates the rear-view of the lamp. This view shows the required components and the assembling mechanism. The components include fiber optics 2, light sources 3, control unit 4, and battery housing 5.

Fiber optics 2 of Exhibit 2 transmits the light. One end of the fiber optics is mounted to the see-through holes from the lamp rear surface. The other end of the fiber optics is assembled and bundled into groups. The number of groups corresponds to the number of light sources. Each group is attached to a light sources 3.

The light sources 3 of Exhibit 2 are single-colored light emitted diodes (LEDs) or other lights that are appropriate to the design.

The control unit 4 of Exhibit 2 modulates the light emitting pattern and sound.

The control unit contains a MT3162 model IC. Exhibit 3 illustrates the IC circuit flow diagram. The three outlet L1, L2 and L3 of the model MT3162 is connected respectively to a single-colored light source, i.e., a LED. This IC controls the current, voltage, and the lighting pattern such as the illuminating sequence, light starting time, and duration. This lighting pattern makes the lamp illuminate with different graphic and intensity, and thus, achieve a more complex and colorful visual effects. The control unit is powered by battery and is connected to the battery housing 5 of Exhibit 2.

The battery housing 5 is for batteries that supply the electric power of the lamp.

The invented decorative lamp has the following advantages:
1. The invented lamp is simple in design. The invented decorative lamp does not contain mechanic components, and thus is simpler in design and compact in volume. The lamp has a lower defect rate and less production costs.
2. The invented lamp has a wider range of application. The lamp could be manufactured as many smaller decorative lights such as Christmas ornaments, lighting door wreath, lighting doormats, lighting name tags, and etc. The design has a wider range of applications and potentially a bigger market.
3. The lamp uses IC to control the lighting pattern. The lighting pattern design can vary significantly. The lamp would illuminate in different graphics, intensities, and sparkling styles. Thus, the lamp has a more colorful and dramatic visual effect. As a result, the invented decorative lamp if it is used for Christmas will be more colorful, adaptable, and compact than current Christmas lights.
4. The invented decorative lamp uses direct electric current and thus is easy of use.
5. The lamp surface are embedded with many small glass balls. These glass balls reflect lights and make the lamp more colorful.

The invented decorative lamp design amends several disadvantages existing in the current decorative lamp market. The invented lamp design uses fiber optics to allow a more elaborative and complex graphic design in a much smaller lamp surface. This lamp is compact and easy to adapt to various decorative settings. Not only the lamp costs less to produce, the lamp has a lower defect rate with a wider range of applications.

1. A decorative lamp design comprising (1) a clear glass ball embedded lamp surface in which the outline of the graphic or shape is comprise of many small holes that filled with fiber optics, (2) fiber optics which transmit light from the light source, (3) the light source which are emitted diodes (leds) and are connected to a control unit, (4) a control unit that using integrated circuit to control lighting patterns and sounds, and (5) the battery housing for battery to power the lamp.
